(19) United States
(12) Patent Application Publication
(10) Pub. No.: US 2025/0319731 A1
(43) Pub. Date: Oct. 16, 2025

(54) Trailer Theft Lock

(71) Applicant: Rondoyle Glenn, Hamtramck, MI (US)

(72) Inventor: Rondoyle Glenn, Hamtramck, MI (US)

(21) Appl. No.: 18/981,863

(22) Filed: Dec. 16, 2024

Related U.S. Application Data
(63) Continuation-in-part of application No. 18/482,857, filed on Oct. 7, 2023, now Pat. No. 12,240,282.
Application No. 18/482,857 is a continuation of application No. 17/150,605, filed on Jan. 15, 2021, now Pat. No. 11,912,081.
(60) Provisional application No. 62/961,312, filed on Jan. 15, 2020.

(51) Int. Cl. B60D 1/60; B60D 1/04; G01S 19/42

(52) U.S. Cl. CPC B60D 1/60; B60D 1/04; G01S 19/42

(57) ABSTRACT

A trailer hitch lock includes a hitch connector enclosure having an enclosure top element coupled to an enclosure bottom element by a pair of opposing enclosure side walls and an enclosure front element. The enclosure front element is coupled between the enclosure top element and enclosure bottom element along the pair of long edges and coupled to the pair of opposing enclosure side walls along the side edges. A pair of matching T-shaped cutouts in the top plate and the bottom plate is centered along a back edge for surrounding the mounting bracket coupled to the trailer hitch. A removable lock secures the trailer hitch lock to the trailer hitch when the trailer hitch is within the trailer hitch enclosure and the trailer hitch enclosure covers a portion of the mounting bracket where the trailer hitch connector is coupled to the mounting bracket by one or more mounting devices.

### CROSS-REFERENCE TO RELATED APPLICATION

This application claims priority to U.S. patent application Ser. No. 17/150,605, filed on Jan. 15, 2021, which itself claims priority to U.S. Provisional Patent Application No. 62/961,312, titled “Mean Dog Eye Lock,” and filed on Jan. 15, 2020. The entire application is incorporated herein by reference in its entirety.

### TECHNICAL FIELD

This application relates in general to an article of manufacture for providing a trailer aid, and more specifically, to an article of manufacture providing a trailer ball hitch lock.

### BACKGROUND

Trailer thefts are on the rise. It is difficult to track stolen trailers, especially since some states don't require certain ones to be registered. More importantly, it takes minutes to back up a truck, unhitch an unprotected trailer, and steal it and its contents. Authorities even report cases of “transloading” where thieves steal a trailer, drive it to another location, empty its contents into a legally owned trailer, and leave the stolen trailer behind. The total loss is often in the tens of thousands of dollars. Trailer hitch locks are a good deterrent, but current locks on the market are easy to work around.

All of the above is especially true of larger trailers that use a lunette ring trailer hitch to permit items such as chippers, generators, dumpsters, and similar trailered devices weighing between 25,000 lbs. and 50,000 lbs. to be towed from one location to another. These trailers and items are expensive and are typically left out on job sites from time to time in which they may be unattended. To protect these trailers from theft, some people use a simple trailer hitch lock that is secured within the hitch connector that connects to a hitch of a vehicle so that it may be towed. Unfortunately, ball hitches have additional weaknesses in the manner that the ball hitches are mounted to a trailer that permit additional ball hitches to be attached to a mounting plate that bypasses the ball hitches having a lock. Alternatively, the mounting brackets are typically coupled to the trailer in a fashion that permits the entire mounting bracket to be removed and a new mounting bracket and replacement lunette ring installed in its place, all without removing the existing lunette ring locks. As such, the existing ball hitches locks do not provide adequate security to trailers on which they are installed.

Therefore, a need exists for an article of manufacture for providing a ball hitches trailer hitch lock. The present invention attempts to address the limitations and deficiencies in prior solutions according to the principles and example embodiments disclosed herein.

### SUMMARY

In accordance with the present invention, the above and other problems are solved by providing an article of manufacture for a lunette ring trailer hitch lock according to the principles and example embodiments disclosed herein.

In one embodiment, the present invention is a trailer hitch lock for surrounding a trailer hitch in which the trailer hitch is coupled to a mounting bracket on a trailer having a plurality of parallel opposing pairs of mounting holes for securing a trailer hitch connector. The trailer hitch lock includes a hitch connector enclosure having an enclosure top element coupled to an enclosure bottom element by a pair of opposing enclosure side walls and an enclosure front element. The enclosure front element is coupled between the enclosure top element and enclosure bottom element along the pair of long edges and coupled to the pair of opposing enclosure side walls along the side edges. A pair of matching T-shaped cutouts in the top plate and the bottom plate are centered along a back edge for surrounding the mounting bracket coupled to the trailer hitch. A removable lock secures the trailer hitch lock to the trailer hitch when the trailer hitch is within the trailer hitch enclosure and the trailer hitch enclosure covers a portion of the mounting bracket where the trailer hitch connector is coupled to the mounting bracket by one or more mounting devices.

In another aspect of the present disclosure, the removable lock is a puck lock.

In another aspect of the present disclosure, the trailer hitch connector couples to a trailer ball hitch, and the one or more mounting devices comprise nut-bolt pairs.

In another aspect of the present disclosure, the enclosure front element is configured to match the shape of the enclosure top element and the enclosure bottom element.

In another aspect of the present disclosure, the enclosure front element comprises two or more front panel elements.

In another aspect of the present disclosure, the trailer hitch lock also includes a rectangular blocking tube coupled to the enclosure top element adjacent to the top notch extending upward from the enclosure top element; and a pair of vertical support elements coupled to one side of the rectangular blocking tube at a lower end and coupled to the enclosure top element adjacent to its matching T-shaped cutout.

In another aspect of the present disclosure, the trailer hitch lock further comprises a hitch ball plate coupled to a hitch ball for securing the trailer hitch lock to the trailer.

In another aspect of the present disclosure, the hitch ball couples to the trailer hitch connector when the trailer hitch lock is attached to the trailer hitch.

In another aspect of the present disclosure, the trailer hitch lock also includes an enclosure locking tab 301a coupled to the trailer hitch enclosure; and a ball plate tab 301b coupled to the hitch ball plate. The enclosure locking tab and the ball plate tab are configured to be adjacent to each other when the trailer hitch lock is attached to the trailer hitch.

In another aspect of the present disclosure, the removable lock is coupled to the enclosure locking tab and the ball plate tab when the enclosure locking tab and the ball plate tab are adjacent to each other to secure the trailer hitch lock to the trailer hitch.

In another embodiment, the present invention is a trailer hitch lock for surrounding a trailer hitch. The trailer hitch is coupled to a mounting bracket on a trailer having a plurality of parallel opposing pairs of mounting holes for securing a trailer hitch connector. The trailer hitch lock includes a trailer hitch enclosure having an enclosure top element coupled to an enclosure bottom element by a pair of opposing enclosure side walls and an enclosure front element having a pair of side edges. The enclosure front element is coupled between the enclosure top element and enclosure bottom element along the pair of long edges and coupled to the pair of opposing enclosure side walls along the side edges. A pair of matching T-shaped cutouts in the top plate and the bottom plate is centered along a back edge for surrounding the mounting bracket coupled to the trailer hitch; a removable lock secures the trailer hitch lock to the trailer hitch when the trailer hitch is within the trailer hitch enclosure; a rectangular blocking tube couples to the enclosure top element adjacent to the top notch extending upward from the enclosure top element, and a pair of vertical support elements couples to one side of the rectangular blocking tube at a lower end and couples to the enclosure top element adjacent to its matching T-shaped cutout.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of a trailer ball hitch and a trailer ball hitch lock according to the present invention.

FIG. 2 illustrates an example embodiment of a trailer ball hitch lock coupled in place onto a trailer ball hitch according to the present invention.

FIG. 3 illustrates a bottom isometric view of a trailer ball hitch lock and a trailer ball hitch mount according to the present invention

FIG. 4 illustrates a bottom isometric view of a trailer ball hitch lock and a trailer ball hitch according to the present invention.

FIGS. 5a-c illustrate various top and bottom views of a trailer ball hitch lock coupled to a trailer ball hitch according to the present invention.

FIG. 6 illustrates an exploded view of a trailer ball hitch lock according to the present invention.

### DETAILED DESCRIPTION

This application relates in general to an article of manufacture for providing a trailer aid, and more specifically, to an article of manufacture for providing a lunette ring trailer hitch lock according to the present invention.

This application relates in general to an article of manufacture for providing a trailer aid, and more specifically, to an article of manufacture for providing a ball trailer hitch lock according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context dictates otherwise. Thus, for example, reference to “a needle” includes reference to one or more of such needles, and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “worker” and “user” refer to an entity, e.g., a human, using an article of manufacture for providing a lunette ring trailer hitch lock associated with the invention. The term user herein refers to one or more users.

The terms “invention” or “present invention” refer to the invention being applied for via the patent application with the title “Trailer Hitch Lock.” Invention may be used interchangeably with lock.

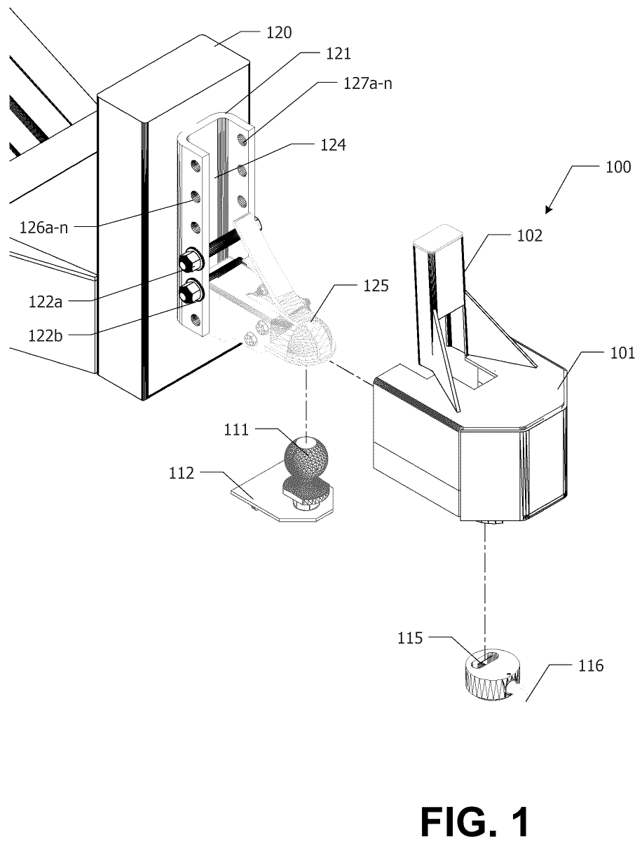

In general, the present disclosure relates to an article of manufacture for providing a trailer ball hitch lock. To better understand the present invention, FIG. 1 illustrates an example of a trailer ball hitch coupled to a mounting bracket for use with the present invention. A trailer ball hitch connector 125 attaches to trailer 120 to permit items such as chippers, generators, dumpsters, and similar trailered devices weighing between 25,000 lbs. and 50,000 lbs. to be towed from one location to another. A mounting bracket 121 attaches to a flat vertical surface on the trailer using a mechanical coupling mechanism through a mounting bracket 121 and trailer 120. For example, nut-bolt pairs may be used to couple the mounting bracket 121 to a trailer. The mounting bracket 121 is constructed by a U-shaped base bracket element having a series of parallel mounting holes 126a-n and 127a-n running along a pair of side bracket elements 123a-c of the mounting bracket 121 that extends perpendicular to the trailer 120. A ball hitch connector 125 is placed between the pair of side bracket elements 123a-b and aligns one or more through-holes 126a-n and 127a-n in mounting bracket 121. A nut-bolt pair 122a-b passes through the mounting bracket 121 and the through-holes 126a-n and 127a-n in the ball hitch connector 125 to be secured to the mounting bracket 121. The ball hitch connector 125 may be coupled to a hitch (not shown) mounted onto a vehicle to tow the trailer.

The mounting bracket 121 is coupled to the trailer 120 in a standard configuration on a front side of the trailer 120 to be towed. The one or more through-holes 126a-n and 127a-n permits various types of hitches to be secured to the trailer 120. For example, FIG. 1 shows a ball hitch connector 125 permitting the trailer 120 to be towed by a vehicle having a ball hitch. An example of a lunette ring hitch coupling to the mounting bracket 121 is shown in the commonly assigned U.S. Pat. No. 11,912,081 referenced above.

As shown in FIG. 1, the nut-bolt pairs 122a-b engage a sequential pair of parallel mounting holes 126a-n, 127a-n to place the ball hitch connector 125 at a desired height on the trailer. The ball hitch connector 125 may be located in several different positions by using the sequential pair of parallel mounting holes 126a-n and 127a-n at various locations within the mounting bracket 121.

Current hitches permit a trailer to be stolen by connecting an exposed ball hitch connector 125 to a vehicle and towing the trailer. To prevent such thefts, hitch locks may be attached to the hitch to eliminate a connection to a vehicle's hitch. Current lock designs typically cover the ball hitch connector 125, or similar connects on other types of hitches. These locks do not eliminate a threat of theft as a separate hitch connector (not shown) may be coupled to the mounting bracket 121 using one or more of the unused pairs of opposing parallel mounting holes 126a-n, 127a-n thereby permitting the newly added hitch connector to be coupled to a vehicle and allowing the trailer 120 to be towed.

Additionally, a lock covering a ball hitch connector 125 does not prevent the removal of the nut-bolt pairs 122a-b to remove a current hitch connector and allow a replacement hitch connector to be added.

For a trailer hitch lock 100 to successfully protect a trailer having a ball hitch connector 125 of this type, the ball hitch connector 125 must be secured to prevent it from being mounted onto a hitch and towed away and the nut-bolt pairs 122a-b used to attach the ball hitch connector 125 to the mounting bracket 121 must be protected. The trailer hitch lock 100 of the present invention addresses vulnerabilities of the trailer hitch in ways not addressed in prior solutions.

The trailer hitch lock 100 uses a hitch connector enclosure 101 and a mounting channel blocking element 102 to prevent access to the mounting bracket 121 thus eliminating the above deficiencies of existing designs. The hitch connector enclosure 101 is placed over the ball hitch connector 125 and the mounting bracket 121 when the trailer hitch lock 100 is installed in a locked position. The nut-bolt pairs 122a-b also are covered by the hitch connector enclosure 101 and all of the pairs of opposing parallel mounting holes 126a-n, 127a-n are blocked from accepting additional nut-bolt pairs 122a-b by the mounting channel blocking element 102.

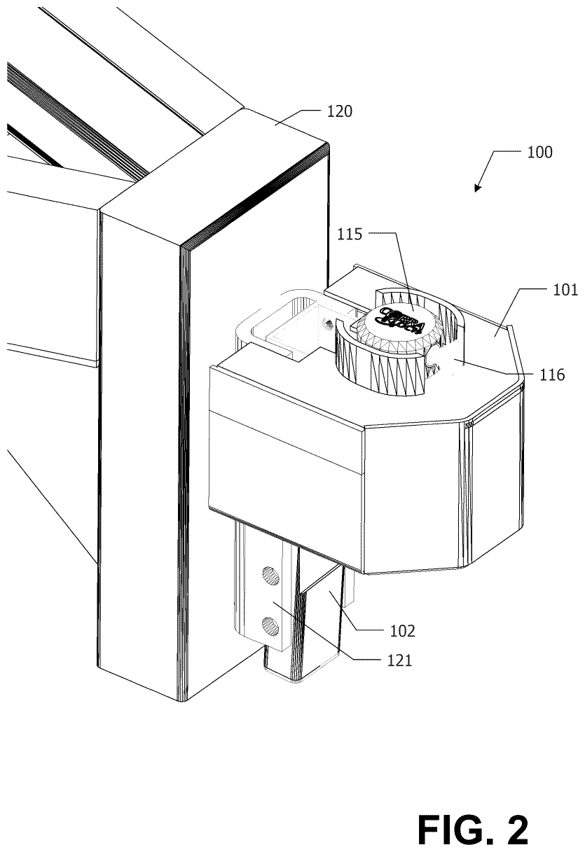

FIG. 2 illustrates a bottom isometric view of an example embodiment of a trailer ball hitch lock coupled in place onto a trailer ball hitch according to the present invention. The trailer hitch lock 100 is shown in place abutting the trailer 120. The hitch connector enclosure 101 covers the ball hitch connector 125 and its coupling to the mounting bracket 121. With the trailer hitch lock 100 in place, the nut-bolt pairs 122a-b, and the parallel mounting holes 126a-n and 127a-n of the mounting bracket 121 are located within the hitch connector enclosure 101. The trailer hitch lock 100 prevents an individual from disconnecting the ball hitch connector 125 from the mounting bracket 121 and replacing it with another hitch to tow away the trailer 120. The hitch connector enclosure 101 enclosing the nut-bolt pairs 122a-b and parallel mounting holes 126a-n and 127a-n also prevents the individual from adding a second ball hitch connector (not shown) above or below the trailer hitch lock 100 in an attempt to tow the trailer 120 while the trailer hitch lock 100 is in place covering the ball hitch connector 125.

Additionally, the mounting channel blocking element 102 is positioned within the mounting bracket channel 124 of the mounting bracket 121 blocking access to any of the parallel mounting holes 126a-n and 127a-n that are outside of the hitch connector enclosure 101. This mounting channel blocking element 102 eliminates any attempt to add a second ball hitch connector to the mounting bracket 121 below the trailer hitch lock 100.

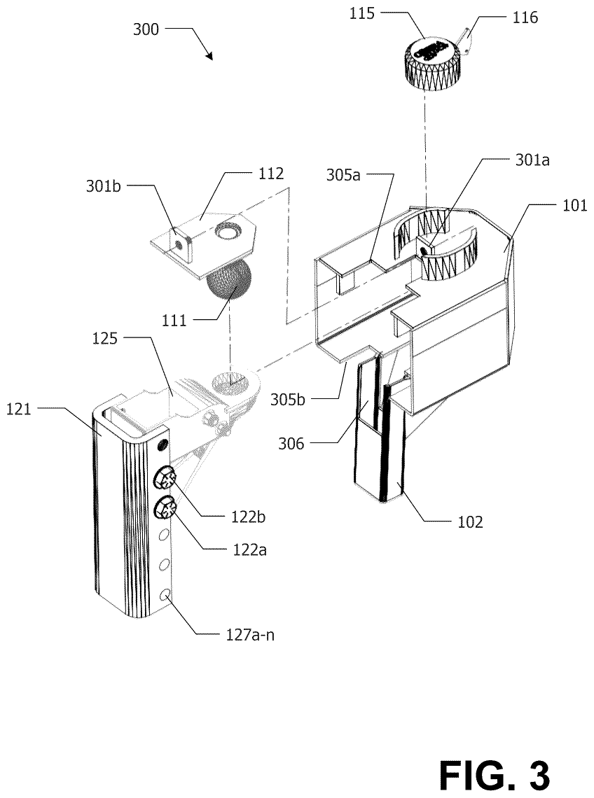

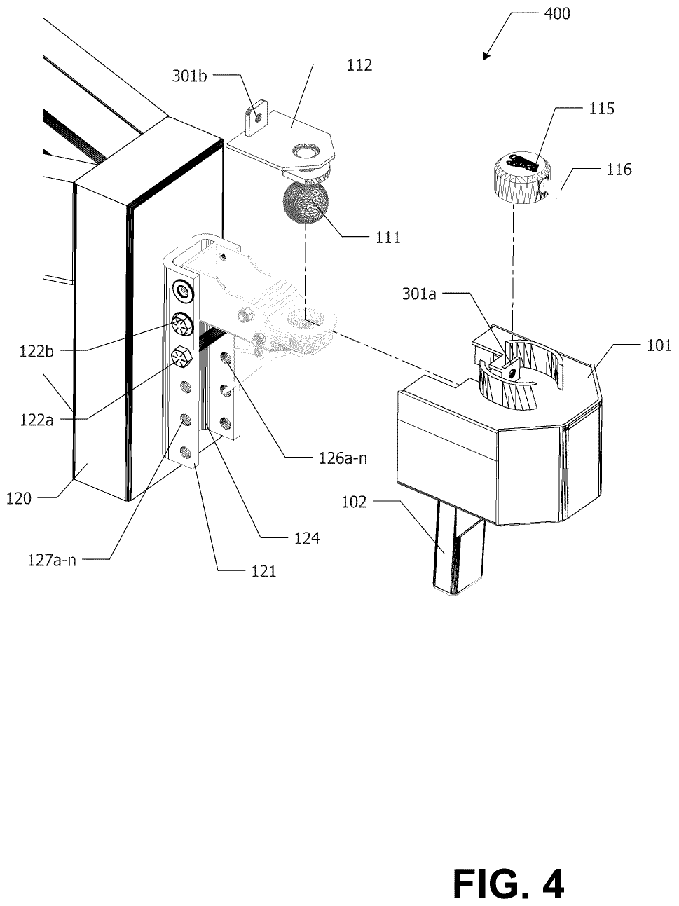

The trailer hitch lock 100 is secured in place with the puck lock 115 holding the trailer hitch lock 100 in place. The puck lock 115 may be operated using a lock key 116 or any similar locking control. The puck lock 115 operates by coupling the hitch ball 111 within the hitch connector enclosure 101 as described in detail herein in reference to FIGS. 3-4. A user may remove the puck lock 115 using the lock key 116 to permit the trailer hitch lock 100 to be removed and the trailer hitch to be accessed to tow the trailer 120.

FIG. 3 illustrates a bottom isometric view of a trailer ball hitch lock and a trailer ball hitch mount according to the present invention. The trailer hitch lock 100 is secured by inserting the hitch ball 111 into the ball hitch connector 125 in the manner a ball hitch is used to tow the trailer 120. The hitch ball 111 is coupled to the hitch ball plate 112 having a ball plate tab 301b extending parallel to the hitch ball 111 on an opposite side of the hitch ball plate 112. As noted above, the ball hitch connector 125 is coupled to the trailer 120 via the mounting bracket 121 using the nut-bolt pairs 122a-b.

Once the hitch ball 111 is inserted into the ball hitch connector 125, the hitch connector enclosure 101 may be positioned to permit the ball hitch connector 125 to be inserted into the hitch connector enclosure 101. An enclosure locking tab 301a is coupled to the outside of the hitch connector enclosure 101 and configured to be positioned adjacent to the ball plate tab 301b once the ball hitch connector 125 is completely within the hitch connector enclosure 101. Both the enclosure locking tab 301a and the ball plate tab 301b include a through-hole configured to align to create a single combined through hole that engages the puck lock 115 when locked in place.

The hitch connector enclosure 101 is shaped to enclose the mounting bracket 121 and position the hitch connector enclosure 101 to abut the trailer 120. The hitch connector enclosure 101 includes matching cutouts 305a-b in the top and bottom surfaces of the hitch connector enclosure 101 to match the shape around the mounting bracket 121 when the trailer hitch lock 100 is in place. A second cutout 306 is included in the inward side of the mounting channel blocking element 102 to accept any items within the mounting bracket channel 124 that need to be enclosed within the mounting channel blocking element 102 when the trailer hitch lock 100 is in place.

When in the trailer hitch lock position, the nut-bolt pairs 122a-b and the parallel mounting holes 126a-n and 127a-n are not accessible within the hitch connector enclosure 101. The hitch connector enclosure 101 cannot be removed to access the nut-bolt pairs 122a-b and parallel mounting holes 126a-n and 127a-n without removing the puck lock 115 allowing the enclosure locking tab 301a and ball plate tab 301b to separate.

FIG. 4 illustrates another bottom isometric view of a trailer ball hitch lock and a trailer ball hitch according to the present invention. The trailer hitch lock 100 is shown from a view 300 from an opposite direction from the view 400 shown in FIG. 3. The mounting bracket channel 124 is shown with the parallel mounting holes 126a-n and 127a-n on either side of the mounting bracket 121. The mounting channel blocking element 102 is coupled to the hitch connector enclosure 101 and is inserted into the mounting bracket channel 124 when the hitch connector enclosure 101 is placed over the ball hitch connector 125. The mounting channel blocking element 102 is within the mounting bracket channel 124 when the hitch connector enclosure 101 is abutting the trailer 120 and the enclosure locking tab 301a and ball plate tab 301b are together for locking using the puck lock 115.

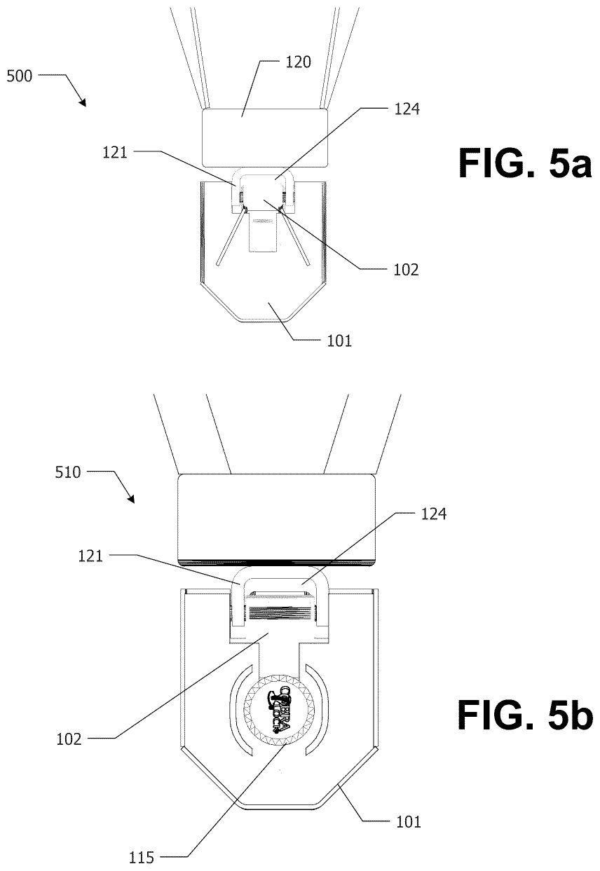

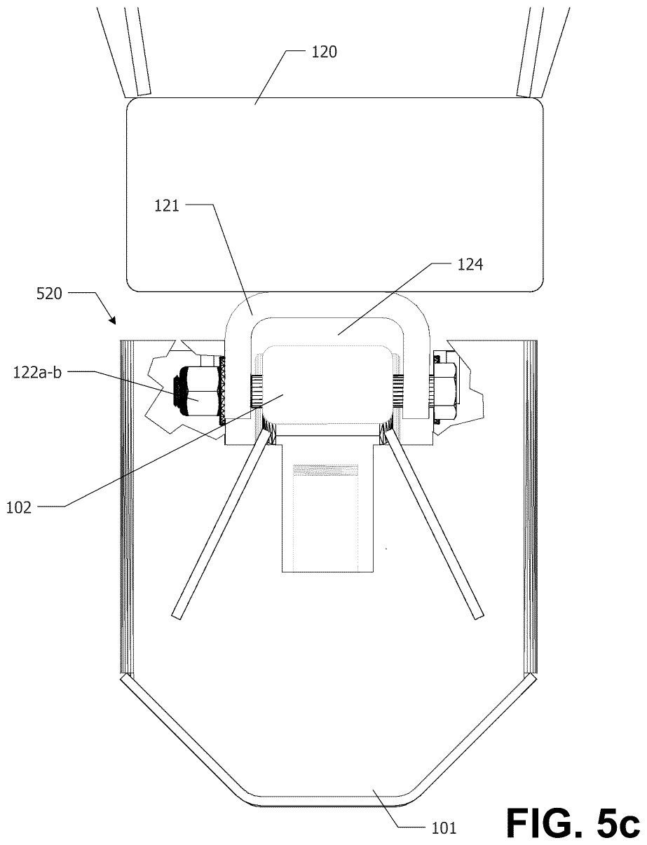

FIGS. 5a-c illustrate various top and bottom views of a trailer ball hitch lock coupled to a trailer ball hitch according to the present invention. FIG. 5a shows a top view 500 of the trailer hitch lock 100 locked into place on a trailer 120. The mounting bracket 121 is shown coupled to the trailer 120 with the mounting channel blocking element 102 within the mounting bracket channel 124. The hitch connector enclosure 101 is shown around the hitch with access within the hitch connector enclosure 101 blocked with the rear edge of the hitch connector enclosure 101 abutting the trailer 120 with the mounting bracket 121 therein.

The hitch connector enclosure 101 covers both the nut-bolt pairs 122a-b and a center portion of the parallel mounting holes 126a-n and 127a-n. The mounting channel blocking element 102 being placed within the mounting bracket channel 124 blocks the portion of the parallel mounting holes 126a-n and 127a-n that are outside the hitch connector enclosure 101. This arrangement prevents the removal of the ball hitch connector 125 and/or the addition of a second ball hitch connector (not shown) to tow the trailer 120 from its current location.

FIG. 5b shows a bottom view 510 of the trailer hitch lock 100 locked into place on a trailer 120. Once again, the mounting bracket 121 is shown coupled to the trailer 120 with the mounting channel blocking element 102 within the mounting bracket channel 124. The hitch connector enclosure 101 is shown around the hitch with access within the hitch connector enclosure 101 blocked with the rear edge of the hitch connector enclosure 101 abutting the trailer 120 with the mounting bracket 121 therein.

The puck lock 115 is shown locked in place along the bottom surface of the hitch connector enclosure 101. As noted herein, the puck lock 115 couples the enclosure locking tab 301a and the ball plate tab 301b together after the hitch ball 111 and the hitch ball plate 112 are coupled to the hitch of the ball hitch connector 125. As noted above in reference to FIG. 5a, the hitch connector enclosure 101 covers the nut-bolt pairs 122a-b and the parallel mounting holes 126a-n and 127a-n with the hitch connector enclosure 101 filling the mounting bracket channel 124 to prevent modification of the trailer 120 and its hitch.

FIG. 5c shows another top view 520 of the trailer hitch lock 100 locked into place on a trailer 120. In this top view 520, the position of the nut-bolt pairs 122a-b is shown within the hitch connector enclosure 101. This position within the hitch connector enclosure 101 prevents an individual from accessing the nut-bolt pairs 122a-b while the trailer hitch lock 100 is locked in place.

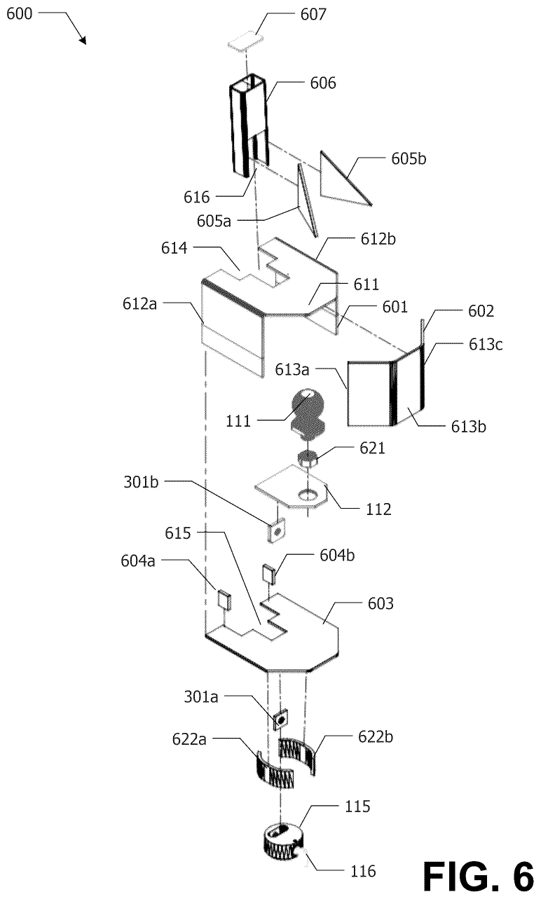

FIG. 6 illustrates an exploded view 600 of a trailer ball hitch lock according to the present invention. Shown in FIG. 6, the components of the trailer hitch lock 100 include: the hitch connector enclosure 101 made using an enclosure top element 601, an enclosure front element 602, an enclosure bottom element 603, a pair of channel guide tabs 604a-b, the mounting channel blocking element 102 made from a channel blocking tube 606 and a channel element top cover 607, a pair of vertical support elements 605a-b, the hitch ball 111, the hitch ball plate 112, a hitch ball locking nut 621, the enclosure locking tab 301a and ball plate tab 301b, a pair of puck lock enclosing wall elements 622a-b, and the puck lock 115 and its corresponding lock key 116.

The hitch connector enclosure 101 may be made using the enclosure top element 601, the enclosure front element 602, and the enclosure bottom element 603, The enclosure top element 601 has an enclosure top surface 611 and a pair of enclosure side walls 612a-b extending downward from sides of the enclosure top surface 611.

The enclosure front element 602 has a plurality of front panel elements 613a-c coupled in a row. FIG. 6 shows a 3-panel enclosure front element 602. A first front-panel element 613a and a third front-panel element 613c are arranged at an angle from their coupling edges with a second-panel element 613b. The first front panel element 613a and the third front panel element 613c are oriented toward the back of the trailer hitch lock 100 to match a front edge of the enclosure top element 601. The first front panel element 613a also is coupled to a first enclosure side wall 612a and the third front panel element 613c also is coupled to the second enclosure side wall 612b. When the enclosure front element 602 is coupled to the enclosure top element 601, a cavity within the trailer hitch lock 100 is created to accept the ball hitch connector 125 and the mounting bracket 121.

The enclosure bottom element 603 is shaped to mirror the enclosure top surface 611 enabling its coupling to the combined enclosure top surface 611 and the pair of enclosure side walls 612a-b. The enclosure bottom element 603 creates a bottom side to the cavity within the hitch connector enclosure 101. The enclosure top surface 611 and the enclosure bottom element 603 also include a pair of matching “T-shaped” cutouts 614-615 to accept the mounting bracket 121 within both elements when the trailer hitch lock 100 is in place.

The pair of channel guide tabs 604a-b are coupled to the enclosure bottom element 603 extending upward toward the enclosure top surface 611. The pair of channel guide tabs 604a-b are positioned along the sides of the pair of matching “T-shaped” cutouts 614-615.

The mounting channel blocking element 102 may be made from a channel blocking tube 606 and a channel element top cover 607. The channel blocking tube 606 is a rectangular hollow tube having an opening 616 on a side of the channel blocking tube 606 facing outward toward the front of the hitch connector enclosure 101. The opening 616 extends a partial way upward on this one side of the channel blocking tube 606 from its bottom edge. The channel element top cover 607 is coupled to a top edge of the channel blocking tube 606 preventing access from outside the trailer hitch lock 100 into a cavity within the channel blocking tube 606.

The pair of vertical support elements 605a-b are triangular-shaped tabs having a right angle at its base in which the bottom edge of each triangle of the pair of vertical support elements 605a-b are coupled to the enclosure top surface 611 and the side edges of each triangle of the pair of vertical support elements 605a-b are coupled to the channel blocking tube 606 above the opening 616. When the pair of vertical support elements 605a-b is coupled in place, the channel blocking tube 606 is positioned within the bottom leg of the matching “T-shaped” cutouts 614-615.

The hitch ball 111 is coupled to the hitch ball plate 112 as described herein in reference to FIGS. 3-4. The hitch ball 111 is secured to the hitch ball plate 112 using a hitch ball locking nut 621 that accepts a threaded end of the hitch ball 111.

As described herein in reference to FIGS. 3-4, the enclosure locking tab 301a and ball plate tab 301b are located adjacent to each other when the hitch ball 111 is attached to the ball hitch connector 125 and the trailer hitch lock 100 is placed about the ball hitch connector 125. The ball hitch connector 125 slides within the cavity of the hitch connector enclosure 101 until the enclosure locking tab 301a and the ball plate tab 301b touch. The trailer hitch lock 100 may be secured in place by attaching the puck lock 115 to the enclosure locking tab 301a and the ball plate tab 301b.

The pair of puck lock enclosing wall elements 622a-b is coupled to the outside surface of the enclosure bottom element 603 about the ball plate tab 301b. The pair of puck lock enclosing wall elements 622a-b is configured to enclose the puck lock 115 within a space between the pair of puck lock enclosing wall elements 622a-b. An opening between the pair of puck lock enclosing wall elements 622a-b allows the lock key 116 to be inserted within the puck lock 115 to unlock the puck lock 115. The pair of puck lock enclosing wall elements 622a-b surround the puck lock 115 when in place to reduce chances of tampering with the puck lock 115 and allow the removal of the trailer hitch lock 100.

The puck lock 115 may utilize its corresponding lock key 116 to control its operation. One of ordinary skill will recognize that other forms of removable locks may be used in place of a key-operated puck lock 115. For example, a combination lock and a biometrically controlled lock may also be used to lock the trailer hitch lock 100 to the trailer 120 as disclosed herein.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act or instruction used in the present application should be construed as critical or essential to the invention unless explicitly described as such. Further, the phrase “based on” is intended to mean “based, at least in part, on” unless explicitly stated otherwise.

What is claimed:

1. A trailer hitch lock for surrounding a trailer hitch, the trailer hitch coupled to a mounting bracket on a trailer having a plurality of parallel opposing pairs of mounting holes for securing a trailer hitch connector, the trailer hitch lock comprises:
a trailer hitch enclosure having an enclosure top element coupled to an enclosure bottom element by a pair of opposing enclosure side walls and an enclosure front element having a pair of side edges and, the enclosure front element is coupled between the enclosure top element and enclosure bottom element and coupled to the pair of opposing enclosure side walls;
a pair of matching T-shaped cutouts in the top plate and the bottom plate centered along a back edge for surrounding the mounting bracket coupled to the trailer hitch; and
a removable lock securing the trailer hitch lock to the trailer hitch when the trailer hitch is within the trailer hitch enclosure;
wherein the trailer hitch enclosure covers a portion of the mounting bracket where the trailer hitch connector is coupled to the mounting bracket by one or more mounting devices.

2. The trailer hitch lock according to claim 1, wherein the trailer hitch connector couples to a trailer ball hitch and the one or more mounting devices comprise nut-bolt pairs.

3. The trailer hitch lock according to claim 1, wherein the removable lock is a puck lock.

4. The trailer hitch lock according to claim 1, wherein the enclosure front element is configured to match the shape of the enclosure top element and the enclosure bottom element.

5. The trailer hitch lock according to claim 4, wherein the enclosure front element comprises two or more front panel elements.

6. The trailer hitch lock according to claim 1, wherein the trailer hitch lock further comprises:
a rectangular blocking tube coupled to the enclosure top element adjacent to the top opening extending upward from the enclosure top element; and
a pair of vertical support elements coupled to one side of the rectangular blocking tube at a lower end and coupled to the enclosure top element adjacent to its matching T-shaped cutout.

7. The trailer hitch lock according to claim 1, wherein the trailer hitch lock further comprises a hitch ball plate coupled to a hitch ball for securing the trailer hitch lock to the trailer.

8. The trailer hitch lock according to claim 7, wherein the hitch ball couples to the trailer hitch connector when the trailer hitch lock is attached to the trailer hitch.

9. The trailer hitch lock according to claim 8, wherein the trailer hitch lock further comprises:
an enclosure locking tab 301a coupled to a trailer hitch enclosure; and
a ball plate tab 301b coupled to the hitch ball plate;
wherein the enclosure locking tab and the ball plate tab are configured to be adjacent to each other when the trailer hitch lock is attached to the trailer hitch.

10. The trailer hitch lock according to claim 9, wherein the removable lock is coupled to the enclosure locking tab and the ball plate tab when the enclosure locking tab and the ball plate tab are adjacent to each other to secure the trailer hitch lock to the trailer hitch.

11. A trailer hitch lock for surrounding a trailer hitch, the trailer hitch couples to a mounting bracket on a trailer having a plurality of parallel opposing pairs of mounting holes for securing a trailer hitch connector, the trailer hitch lock comprises:
a trailer hitch enclosure having an enclosure top element coupled to an enclosure bottom element by a pair of opposing enclosure side walls and an enclosure front element having a pair of side edges, the enclosure front element is coupled between the enclosure top element and enclosure bottom element and coupled to the pair of opposing enclosure side walls;
a pair of matching T-shaped cutouts in the top plate and the bottom plate centered along a back edge for surrounding the mounting bracket coupled to the trailer hitch;
a removable lock securing the trailer hitch lock to the trailer hitch when the trailer hitch is within the trailer hitch enclosure; a rectangular blocking tube coupled to the enclosure top element adjacent to the top opening extending upward from the enclosure top element; and
a pair of vertical support elements coupled to one side of the rectangular blocking tube at a lower end and coupled to the enclosure top element adjacent to its matching T-shaped cutout.

12. The trailer hitch lock according to claim 11, wherein the trailer hitch enclosure covers a portion of the mounting bracket where the trailer hitch connector is coupled to the mounting bracket by one or more mounting devices.

13. The trailer hitch lock according to claim 11, wherein the trailer hitch lock further comprises:
an enclosure locking tab 301a coupled to the trailer hitch enclosure; and
a ball plate tab 301b coupled to the hitch ball plate;
wherein the enclosure locking tab and the ball plate tab are configured to be adjacent to each other when the trailer hitch lock is attached to the trailer hitch.

14. The trailer hitch lock according to claim 13, wherein the one or more mounting devices comprise nut-bolt pairs.

15. The trailer hitch lock according to claim 13, wherein the removable lock is a puck lock.

16. The trailer hitch lock according to claim 11, wherein the enclosure front element is configured to match the shape of the enclosure top element and the enclosure bottom element; and the enclosure front element comprises three front panel elements.
